(19) United States
(12) Patent Application Publication
(10) Pub. No.: US 2013/0138578 A1
(43) Pub. Date: May 30, 2013

(54) Systems and Methods for Building Retirement Income

(71) Applicant: THE 401K COACH, LLC, Holyoke, MA (US)

(72) Inventor: Charles D. Epstein, East Longmeadow, MA (US)

(73) Assignee: THE 401K COACH, LLC, Holyoke, MA (US)

(21) Appl. No.: 13/631,441

(22) Filed: Sep. 28, 2012

Related U.S. Application Data
(60) Provisional application No. 61/540,464, filed on Sep. 28, 2011.

(51) Int. Cl. G06Q 40/06

(52) U.S. Cl. CPC G06Q 40/06
USPC 705/36 R

(57) ABSTRACT

The present application is directed to systems and methods for building retirement income. A desirement mortgage may be determined which represents a maximum value of a user account. A supplemental funding source may be used for achieving the maximum value, and a compound interest source may also be used. Periodic inputs may be automatically inputted into the user account. A desirement date may be determined for achieving the maximum value. Periodically, a choice of account may be adjusted or changed based on achieving the maximum value at the desirement date.

### CROSS-REFERENCE TO RELATED APPLICATIONS

The present application claims priority to provisional U.S. Patent Application Ser. No. 61/540,464, filed on Sep. 28, 2011, titled “Paychecks for Life,” which is hereby incorporated by reference in its entirety.

### FIELD OF THE INVENTION

The present application is directed generally to financial systems, and more specifically to financial systems for building retirement income.

### BACKGROUND

According to the 2010 Social Security Administration Period Life Tables, mean life expectancy has risen from sixty-eight years in 1950 to seventy-eight years in 2010. The life expectancy of a person who reaches 65 years old is extended to 83 for a man and 85 for a woman. Thus a person who retires at the age of 65 can expect to live about 20 years, and in many cases longer, without drawing a regular paycheck. Retirement planning is designed to determine the amount of money the person will require to maintain a certain lifestyle after reaching retirement age, then formulate a plan to acquire that amount prior to reaching retirement age.

There are numerous investment vehicles available for accumulating wealth for retirement. These investment vehicles may include stocks, bonds, futures, options, mutual funds and the like. Other investment vehicles may involve the purchase of specific items, such as real estate, collectibles, and precious metals. A common mechanism for utilizing all or a portion of these investment vehicles is a 401(k) plan. Such plans were established through government regulations which specified that employees were not to be taxed on income they chose to receive as deferred compensation rather than direct cash deposits. Although 401(k) plans provide an effective way for an individual to save for retirement, effective planning may be necessary to determine what amount of money should be saved for retirement and how to utilize a 401(k) plan to achieve that goal.

### SUMMARY

Various embodiments of the present disclosure are directed to systems and methods for building retirement income. Input data may be received from a user to establish a user account. A desirement mortgage may be determined which represents a maximum value of the user account. A supplemental funding source may be used for achieving the maximum value, and a compound interest source may also be used. Periodic inputs may be automatically inputted into the user account. A desirement date may be determined for achieving the maximum value. Periodically, a choice of account may be adjusted or changed based on achieving the maximum value at the desirement date.

### BRIEF DESCRIPTION OF THE DRAWINGS

FIG. 1 is an exemplary flow diagram of a method for building retirement income according to various embodiments.

FIG. 2 is an exemplary flow diagram of a method for building retirement income according to various embodiments.

FIG. 3 is a schematic diagram of an exemplary architecture of a system for building retirement income according to various embodiments.

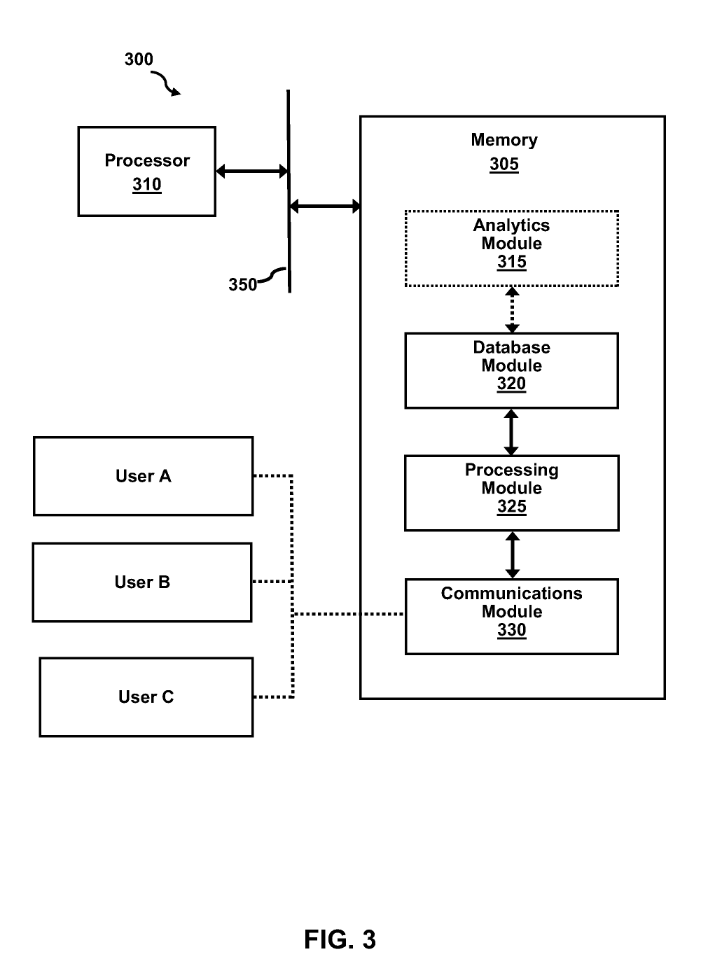

FIG. 4 is a block diagram of an exemplary computing system that may be utilized to practice aspects of the present disclosure according to various embodiments.

### DETAILED DESCRIPTION

Various embodiments of the present disclosure are directed to systems and methods for building retirement income. Input data may be received from a user to establish a user account. Based on at least a portion of the input data, a desirement mortgage may be determined which represents a maximum value of the user account. A supplemental funding source may be used for achieving the maximum value, and a compound interest source may also be used. Periodic inputs may be automatically inputted into the user account to achieve the maximum value. A desirement date may be determined for achieving the maximum value. Periodically, a choice of account may be adjusted or changed based on achieving the maximum value at the desirement date. A choice of account may be periodically adjusted or changed based on minimizing a cost associated with the account choice.

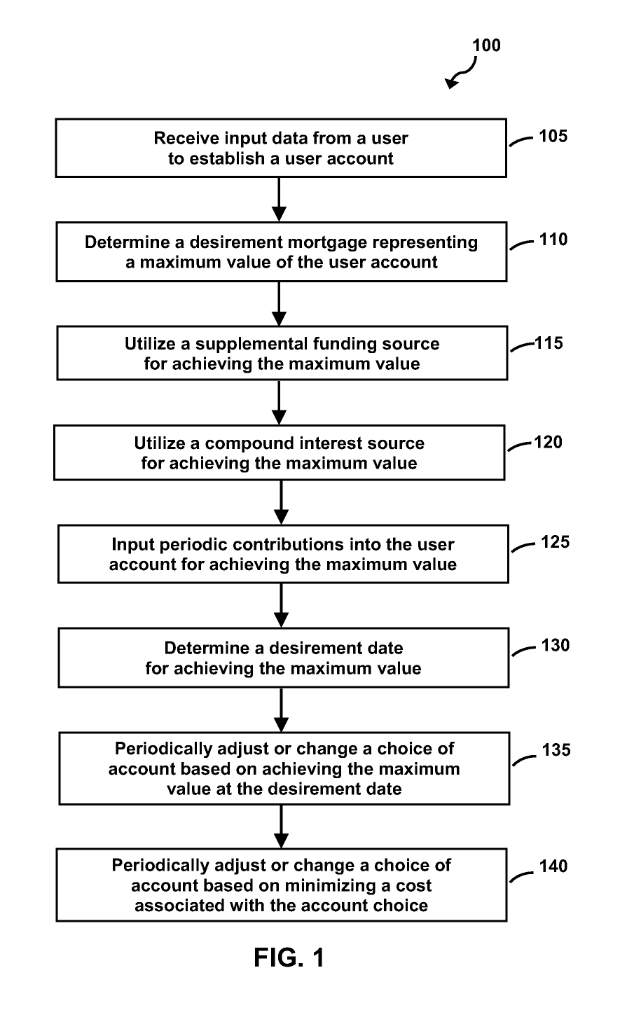

FIG. 1 is a flow diagram of various embodiments of a method 100 for building retirement income. At step 105, input data may be received from a user to establish a user account. The input data may comprise personal data such as name, address, Social Security number, employer, income, and the like. The input data may also comprise information related to retirement, such as the year in which retirement may occur, the lifestyle desired during retirement, expenses during retirement, sources of income during retirement, assets, and debts. The desired retirement lifestyle may comprise activities such as travel, hobbies, and volunteer work, as well as having enough disposable income to help others. Retirement expenses may comprise relatively fixed and recurring expenses such as housing, utilities, food, transportation, healthcare, and taxes. Retirement expenses may also comprise variable discretionary spending related to the desired retirement lifestyle, such as entertainment, travel, education, purchasing of items for oneself or others, and charitable contributions. In general, these variable expenses may be classified as costs of experiences, possessions, and achievements. Alternatively, retirement expenses can be assumed to equal a percentage of current income. The percentage may be less than current income, such as 70 or 80 percent, or it may be greater, such as 120 percent if a very active retirement is anticipated. The sources of income during retirement may comprise Social Security, pensions, and annuities.

For many individuals, the retirement expenses may exceed retirement income. This difference, or income gap, may be filled in part or in whole by a number of sources, including mutual funds, stocks, bonds, certificates of deposit, real estate, individual retirement accounts (IRA), 403b accounts, simplified employee pension (SEP) plan, 401(k) account, and other potential income sources. A gap between retirement expenses and retirement income may still remain even after taking into account these other income sources because many individuals have at most one or two of these income sources. This income gap may be termed the income replacement figure.

At step 110, a desirement mortgage number may be determined. The desirement mortgage number is the amount the user may need to accumulate in an investment account in order to supply an amount equal to the income replacement figure each year during retirement. The desirement mortgage determination may be illustrated through the following example. The user is 35 years old, currently earns an annual salary of $40,000, and plans to retire at age 65. The user assumes that he will need 70 percent of his income, or $28,000, to meet his retirement expenses. However, the $28,000 must be adjusted for inflation. Assuming an annual rate of inflation of 3 percent over 30 years, the user will need $69,963 to achieve the same buying power as the $28,000 provides today. However, inflation may continue through his retirement years, such that by the time he reaches an age of 80, he will need $105,885 per year. At his life expectancy of 86 years, this figure increases to $126,432. Thus, at the point of retirement, the user will require a starting account balance of $1,209,652 to provide the desired 70 percent of income for a predetermined number of years, such as the number of years from retirement up to his life expectancy.

As described previously, the user may have outside sources of funds to help achieve this starting balance. For example, if the user presently has $45,000 in a 401(k) account, the value of the account after 30 years assuming a 6 percent rate of return will be $271,015. The user may also qualify for Social Security benefits, which, by way of example, may be $1,250 per month or $15,000 per year. The present value of the Social Security payments the user would collect to his life expectancy of 86 years is approximately $241,702. Thus, the use will require a balance in an investment account of $1,209,652−($241,702+$271,015)=$696,935 at age 65 to provide annual payments equal to 70 percent of annual income during retirement. This amount, $696,935, is the desirement mortgage number. Stated another way, it is the maximum value the user account needs to obtain by the time the user reaches retirement age in order to achieve the desired retirement income. Other supplemental funding sources may comprise a pension plan and matching employer contributions.

The term desirement “mortgage” is used because the user may now think of the $696,935 as a “mortgage” that he has to make monthly payments into an investment account from his current age of 35 until his retirement age of 65 in order to accumulate the desired amount with compound interest. Assuming he earns 6 percent compounded monthly on his account, the user would have to “pay” $690 per month into his account in order to achieve his desirement mortgage of $696,935 at age 65.

At step 115, a supplemental funding source may be used to achieve the maximum value of the user account, or the desirement mortgage. Although a variety of possible income sources were listed above, the majority of American investors do not individually own stocks, bonds, or other securities. Recent studies have shown that this percentage is approximately 20 percent. However, nearly half of American households participate in a 401(k) plan and another 10 percent have access to a 401(k) plan. Thus, a 401(k) plan may be a source of supplemental income for achieving the desirement mortgage. Most 401(k) plans, in addition to allowing for employee contributions, supplement each account with an employer matching contribution up to a certain percentage of the employee contribution. In some plans, the employer contribution is tied to a profit-sharing plan. Another source of supplemental funding is the federal government through the provisions of the 401(k) regulations. Employee contributions into a 401(k) plan are deducted from a paycheck as pre-tax dollars. In other words, a person in a 25 percent tax bracket that contributes $100 into a 401(k) account will only see a $75 decrease in take home pay. In effect, the federal government is providing $25 of the $100 contribution, and this supplemental funding remains in the account to earn interest. These supplemental funding sources may serve to reduce the amount the user must contribute into the account to reach the desirement mortgage.

To illustrate the effect of supplemental funding, consider again the user from the above example who earns $40,000 and assume he participates in a 401(k) plan where the employer will match half of the first 6 percent of income the user contributes. That is, if the user contributes 6 percent of his pay, the employer will match 3 percent of his pay. The user contributes 10 percent of his pay (before taxes), or $4,000. At a 25 percent tax rate, the user has deferred $1,000 in taxes that he would have had to pay. Thus, the federal government is paying $1,000 of the $4,000 contribution. The employer matching contribution is $1,200 (50 percent of the first 6 percent of pay contributed), for a total supplemental funding of $2,200. This equates to a 73 percent return on the $3,000 investment in the first year. In terms of the $690 monthly payment calculated previously to achieve the desirement mortgage, the federal government is contributing 25 percent of taxable income (taking into account the pre-tax contribution), or $148. The employer matching contribution equates to $100, for a total of $248 of supplemental funding. This equals approximately 35 percent of the total monthly payment, reducing the contribution by the user from $690 to $442.

Returning to FIG. 1, a compound interest source may be utilized at step 120 for achieving the maximum value of the user account. Compound interest may be defined as earning interest not only on principal and on the previous interest earned on the account. To fully understand compound interest, first consider simple interest. With simple interest, the investment vehicle pays interest only on the principal the user has deposited in the account. For example, if the user deposits $1,000 into the account that pays 5 percent simple interest per year, the user will earn $50 after the first year for a total account balance of $1,050. After the second year, the account will earn another $50 interest, making the account balance $1,100. This rate of growth will continue for as long as the original principal is left in the account. Thus, the formula for calculating simple interest is: Account Value=Principal×Rate×Time. Principal is the amount of money the user deposits into the account. Rate is the interest rate expressed as a decimal (for example, the 5 percent interest rate would be 0.05). Time is the number of years the principal remains or will remain in the account. Using this formula, the simple interest on $1,000 invested at a rate of 5 percent for 5 years would be $250 ($1,000×0.05×5), for a total account value of $1,250 after the five year period.

As stated above, a compound interest account earns interest on both the principal and the previous interest earned. Using the same example above, after the first year the account would have the same balance of $1,050. However, starting in the second year, the account will begin to earn interest on the $1,000 principal and the $50 interest. Thus, the interest earned in the second year would be $52.50 compared to the $50 earned under the simple interest model. The formula for compound interest is: Account Value=Principal×(1+Rate)^{Time}. Using this formula, the same $1,000 invested for 5 years at 5 percent compound interest would be worth $1,276.28 ($1,000×(1+0.05)⁵). This is $26.28 more than under the simple interest model. Compound interest sources within a 401(k) plan may include one or more mutual funds or a fixed or variable interest savings account that is not a mutual fund.

The majority of 401(k) plans are set up such that employee input contributions to the user account are made automatically made on a periodic basis (step 125). Most often, these automatic payments are taken directly out of the paycheck of the user as an automatic payroll deduction. Any defined period may be established by the 401(k) plan. For example, if the user is paid ever two weeks, the contribution may be taken out of each paycheck. Alternately, the contributions may be taken out of every other paycheck. The amount of each contribution is typically set once a year. If the user is unable or unwilling to contribute the maximum amount allowed under the plan, the contributions may be periodically increased by a predetermined amount or percentage until the maximum contribution is reached. In addition, the employer contribution may be made on a periodic basis. The period of the employer payments may range from the same period as paychecks are issued up to a single annual payment.

A desirement date may then be established (step 130) which is the future date at which the maximum value of the user account may be obtained. In other words, the desirement date is when the user desires to stop working on a full-time basis and begin drawing funds from the user account to meet his financial needs. The desirement date may correspond to a typical retirement age of 65, some later age or some earlier age. The exact date chosen may be dependent on how long it will take to achieve the maximum value of the user account.

Due to fluctuations in market and economic conditions throughout the world, periodic adjusting or changing of a choice of accounts in which the user account funds are invested may be desirable to achieve the maximum value at the desirement date (step 135). In the context of a 401(k) plan, a choice is usually made by the user as to which of several offered accounts (mutual funds or other investment vehicles) the funds are to be placed. A typical 401(k) plan may offer between 10 and 20 different investment vehicles, typically mutual funds. These mutual funds may follow the follow the following general investment categories: U.S stock funds (comprising large-cap, mid-cap, or small-cap companies), non-U.S. stock funds (comprising developed companies or emerging markets), real estate, resource funds (comprising natural resources or commodities), U.S. bond funds (comprising aggregate bonds or inflation-protected bonds), non-U.S. bond funds, and cash. In order to lessen the risk of sudden downturns in a particular type of fund, it may be prudent to reduce risk by diversifying the account funds between a broad range of asset classes that behave differently and are in different markets. For example the choice of mutual funds should not all be composed of or indexed to a particular industry such as technology or energy. Rather, the funds should be spread among a wide variety of industries so that any downturn in one segment of the market may be offset by gains in another segment. One method of diversification may be to equally divide the funds between all the funds offered by the 401(k) plan.

The diversification of the account should be periodically analyzed to determine whether the choice of investment vehicles is still meeting the goals of the user. One method for achieving this is rebalancing, which is the systematic process of reallocating the assets within the account to keep the share of each asset in line with predetermined percentages. The rebalancing process buys funds when they are low with dollars sold from a fund that is high. This approach increases the probability that the value of the fund will continue to grow at a maximum rate and smoothes out the volatility in an investment portfolio while avoiding emotion-driven decision-making.

Periodically adjusting or changing the choice of investment vehicle may also be done to minimize costs associated with that fund (step 140). For example, there are two basic types of mutual funds: actively managed funds and passively managed index funds. An actively managed fund is one in which the fund manager has discretion over the selection of investments and how long the investments are held. Passively managed index funds (including exchange traded funds (ETFs)) typically mimic a specific stock or bond market index. An index fund manager is generally constrained to holding the same stocks or bonds as the index the fund is attempting to emulate. Because there is less involvement by the fund manager in passively managed index funds, their expenses are typically lower than actively managed funds. Thus, selecting more passively managed index funds may reduce the expenses charged to the account. However, expenses vary from fund to fund regardless of active or passive management, and the selection of the funds may at least in part be based on the annual expenses of each fund. Additional savings on expenses may also be obtained by selecting no-load investment vehicles, which typically do not charge an up-front fee for deposits into the fund.

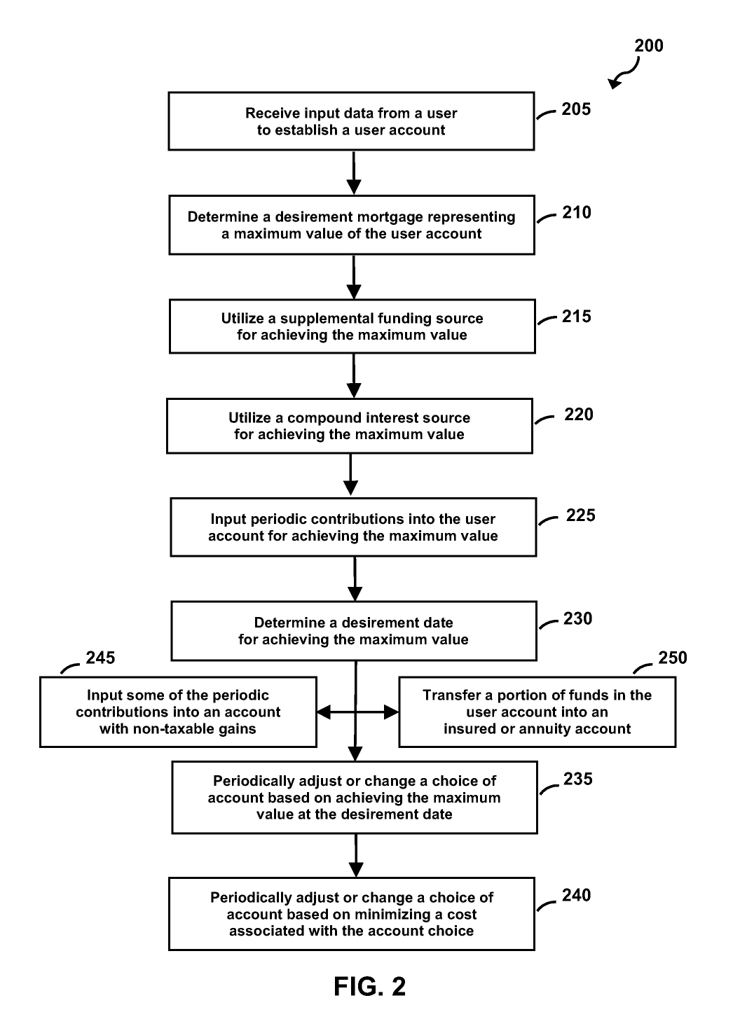

FIG. 2 is a flow diagram of various embodiments of a method 200 for building retirement income. In method 200, steps 205 through 240 are analogous to steps 105 through 140 of method 100 (see FIG. 1). Method 200 may also comprise an additional step (step 245) of transferring at least a portion of the funds in the user account into an account with non-taxable gains. The 401(k) account itself provides for delayed taxability, in which funds are deposited pre-tax and are only taxed when removed from the account after the user reaches a certain age. In contrast, a Roth IRA is funded with post-tax dollars. At the age of 59.5, the funds in a Roth IRA, both principal and interest may be withdrawn tax free. The principal may be withdrawn at any time without penalty, but any interest or earnings on the principal will be subject to a 10 percent penalty if withdrawn before age 59.5 or if the account has been held for less than five years. Additionally, the withdrawals from the Roth IRA will not move the user into a higher tax bracket since the gains are non-taxable.

Method 200 may also comprise an additional step (step 250) of transferring at least a portion of the funds in the user account to an insured or annuity account. Transferring the funds into an insured or annuity account may transfer some or all of the investment risk and longevity risk to an insurance company. Similar to the protection afforded by automobile, fire, and life insurance, an insurance company may protect the funds in the user account from the risks of a prolonged negative market (investment risk) or surpassing the planned life expectancy of the user (longevity risk). The insurance company typically charges a premium or a percentage of the funds each year to insure the funds. The insurance company may protect the full value of the funds, increase the value of the funds by a specified percentage for a specified period of time, guarantee to make annual payments for the life of the user, provide the ability to diversify the funds, and lock in market gains to increase potential lifetime income.

In general terms, an annuity is a contract between the user and an insurance company wherein the user agrees to make one or more payments to the insurance company in exchange for the insurance company making periodic payments to the user. Immediate annuities begin to make payments immediately after inception, typically after a single upfront payment by the user. These payments may continue for the life of the user, regardless of how long he lives. Fixed annuities offer a fixed rate of return for a fixed period of time. At the end of the term of the annuity, the user may withdraw the remaining funds, renew the fixed annuity contract, or convert to an immediate annuity. Indexed annuities will pay the user a percentage of the gain of a specific index, such as the gain of the Standard & Poor's 500. Variable annuities allow the user to make contributions at any time in any amount, but the value of the annuity may change depending on the chosen investment funds. All annuities have certain benefits, drawbacks, and risks that must be balanced by the user to achieve desired goals.

An insured account is a more simplified approach than an annuity in which the insurance company guarantees payments from the user account for as long as the user lives in exchange for regular premium payments. The funds remain in the 401(k) account, but the user is guaranteed a set payment each year regardless of the performance of the account.

The various embodiments of methods 100 and 200 may be carried out using a server comprising at least one central processing unit operatively connected to memory. Code may be stored by the memory that may cause the CPU to perform one or more of the steps of method 100 or 200. FIG. 300 illustrates a system 300 for building retirement income according to method 100 or 200. System 300 may be comprised of a memory 305 for storing executable instructions and a processor 310 for executing the instructions stored in memory 305. The processor 310 and memory 305 may be connected by a single bus 350, or by any other connection device known in the art.

The executable instructions may be comprised of a plurality of modules. In various embodiments, the modules may include a database module 320 configured to receive new and updated information, store and organize the information, and retrieve the information. The information stored in the database module 320 may comprise personal data such as name, address, Social Security number, employer, income, and the like. The information may also comprise information related to retirement, such as the year in which retirement may occur, the lifestyle desired during retirement, expenses during retirement, sources of income during retirement, assets, and debts. Additionally, the information may comprise account information such as a history of deposits, allocation of money into one or more investment vehicles, performance data related to each investment vehicle, present and historical value of the account, and the like. The database module 320 may comprise a relational database such that relationships between the data, such as which funds are associated with each account, are maintained.

A processing module 325 may also be present within the executable instructions that is communicatively coupled to the database module 320. The processing module 325 may execute requests from a variety of users to enter data, retrieve data, analyze data, add or delete users, and handle other operational requests within the system 300.

In addition, the executable instructions may further comprise a communications module 330 communicatively coupled to the processing module 325. The communications module 330 may also be communicatively coupled to a plurality of users, such as users A, B and C. The communications module 330 may receive data from and transmit data to the users A, B, and C.

The executable instructions may optionally include analytics module 315 communicatively coupled to the processing module 325. The analytics module 315 may contain one or more algorithms for performing a variety of analyses on the medical claims data, or any other data stored by the database module 320.

According to some embodiments, the system 300 may include a cloud-based computing environment that collects, processes, analyzes, and publishes datasets. In general, a cloud-based computing environment is a resource that typically combines the computational power of a large grouping of processors and/or that combines the storage capacity of a large group of computer memories or storage devices. For example, systems that provide a cloud resource may be utilized exclusively by their owners, such as Google™ or Yahoo!™, or such systems may be accessible to outside users who deploy applications within the computing infrastructure to obtain the benefits of large computational or storage resources.

The cloud may be formed, for example, by a network of web servers with each server (or at least a plurality thereof) providing processor and/or storage resources. These servers may manage workloads provided by multiple users (e.g., cloud resource customers or other users). Typically, each user places workload demands upon the cloud that vary in real-time, sometimes dramatically. The nature and extent of these variations typically depend upon the type of business associated with each user.

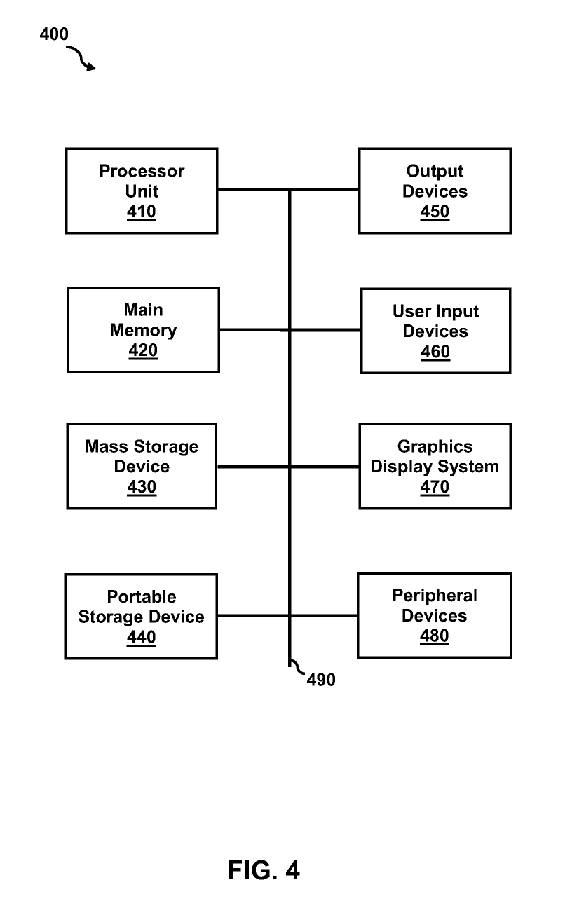

FIG. 4 illustrates an exemplary computing system 400 that may be used to implement various embodiments of the present technology. The computing system 400 of FIG. 4 includes one or more processor units 410 and main memory 420. Main memory 420 stores, in part, instructions and data for execution by processor 410. Main memory 420 can store the executable code when the system 400 is in operation. The system 400 of FIG. 4 may further include a mass storage device 430, portable storage device(s) 440, output devices 450, user input devices 460, a graphics display system 470, and other peripheral devices 480.

The components shown in FIG. 4 are depicted as being connected via a single bus 490. The components may be connected through one or more data transport means. Processor unit 410 and main memory 420 may be connected via a local microprocessor bus, and the mass storage device 430, peripheral device(s) 480, portable storage device(s) 440, and graphics display system 470 may be connected via one or more input/output (I/O) buses.

Mass storage device 430, which may be implemented with a magnetic disk drive or an optical disk drive, is a non-volatile storage device for storing data and instructions for use by processor unit 410. Mass storage device 430 can store the system software for implementing embodiments of the present technology for purposes of loading that software into main memory 420.

Portable storage device 440 operates in conjunction with a portable non-volatile storage media, such as a floppy disk, compact disk or digital video disc, to input and output data and code to and from the computer system 400 of FIG. 4. The system software for implementing embodiments of the present technology may be stored on such a portable media and input to the computer system 400 via the portable storage device 440.

User input devices 460 provide a portion of a user interface. User input devices 460 may include an alphanumeric keypad, such as a keyboard, for inputting alphanumeric and other information, or a pointing device, such as a mouse, a trackball, stylus, or cursor direction keys. Additionally, the system 400 as shown in FIG. 4 includes output devices 450. Suitable output devices include speakers, printers, network interfaces, and monitors.

Graphics display system 470 may include a liquid crystal display (LCD) or other suitable display device. Graphics display system 470 receives textual and graphical information, and processes the information for output to the display device.

Peripheral devices 480 may include any type of computer support device to add additional functionality to the computer system. Peripheral device(s) 480 may include a modem or a router.

The components contained in the computer system 400 of FIG. 4 are those typically found in computer systems that may be suitable for use with embodiments of the present technology and are intended to represent a broad category of such computer components that are well known in the art. Thus, the computer system 400 of FIG. 4 can be a personal computer, hand held computing system, telephone, mobile computing system, workstation, server, minicomputer, mainframe computer, or any other computing system. The computer may also include different bus configurations, networked platforms, multi-processor platforms, etc. Various operating systems can be used including UNIX, Linux, Windows, Macintosh OS, Palm OS, and other suitable operating systems.

Some of the above-described functions may be composed of instructions that are stored on storage media (e.g., computer-readable media). The instructions may be retrieved and executed by the processor. Some examples of storage media are memory devices, tapes, disks, and the like. The instructions are operational when executed by the processor to direct the processor to operate in accord with the technology. Those skilled in the art are familiar with instructions, processor(s), and storage media.

It is noteworthy that any hardware platform suitable for performing the processing described herein is suitable for use with the technology. The terms “computer-readable storage medium” and “computer-readable storage media” as used herein refer to any medium or media that participate in providing instructions to a CPU for execution. Such media can take many forms, including, but not limited to, non-volatile media, volatile media and transmission media. Non-volatile media include, for example, optical or magnetic disks, such as a fixed disk. Volatile media include dynamic memory, such as system RAM. Transmission media include coaxial cables, copper wire and fiber optics, among others, including the wires that comprise one embodiment of a bus. Transmission media can also take the form of acoustic or light waves, such as those generated during radio frequency (RF) and infrared (IR) data communications. Common forms of computer-readable media include, for example, a floppy disk, a flexible disk, a hard disk, magnetic tape, any other magnetic media, a CD-ROM disk, digital video disk (DVD), any other optical media, any other physical media with patterns of marks or holes, a RAM, a PROM, an EPROM, an EEPROM, a FLASHEPROM, any other memory chip or data exchange adapter, a carrier wave, or any other media from which a computer can read.

Various forms of computer-readable media may be involved in carrying one or more sequences of one or more instructions to a CPU for execution. A bus carries the data to system RAM, from which a CPU retrieves and executes the instructions. The instructions received by system RAM can optionally be stored on a fixed disk either before or after execution by a CPU.

As used herein, the terms “having”, “containing”, “including”, “comprising”, and the like are open ended terms that indicate the presence of stated elements or features, but do not preclude additional elements or features. The articles “a”, “an” and “the” are intended to include the plural as well as the singular, unless the context clearly indicates otherwise.

The present invention may be carried out in other specific ways than those herein set forth without departing from the scope and essential characteristics of the invention. The present embodiments are, therefore, to be considered in all respects as illustrative and not restrictive, and all changes coming within the meaning and equivalency range of the appended claims are intended to be embraced therein.

What is claimed is:

1. A system for building retirement income, comprising:
a server comprising at least one central processing unit (CPU) operatively coupled to memory;
code stored by the memory causing the CPU to perform the following steps:
receive input data from a user to establish a user account;
store account data in a database;
determine a desirement mortgage representing a maximum value of the account based on the input data;
utilize a supplemental funding source for achieving the maximum value;
utilize a compound interest source for achieving the maximum value;
automatically input periodic contributions into the account for achieving the maximum value;
determine a desirement date for achieving the maximum value;
periodically adjust or change a choice of account based on achieving the maximum value at the desirement date; and
periodically adjust or change a choice of account based on minimizing a cost associated with the account choice.

2. The system of claim 1, further comprising transferring at least a portion of funds in the user account to an insured or annuity type or choice of account.

3. The system of claim 1, further comprising inputting some of the periodic contributions into an account with non-taxable gains.

4. The system of claim 1, wherein the desirement mortgage comprises fixed costs and variable costs.

5. They system of claim 4, wherein the fixed costs comprise one or more costs for housing, taxes, utilities, food, and transportation.

6. The system of claim 4, wherein the variable costs comprise one or more costs for experiences, possessions, and achievements.

7. The system of claim 1, wherein the desirement mortgage is reduced by an amount of outside income.

8. The system of claim 1, wherein the desirement mortgage represents the cost of maintaining a lifestyle for predetermined number of years.

9. The system of claim 1, wherein the desirement mortgage represents a fixed percentage of annual income.

10. The system of claim 1, wherein determining the desirement mortgage comprises accounting for inflation.

11. The system of claim 1, wherein the supplemental funding source comprises at least one of a matching employer contribution, a pension plan, or Social Security payments.

12. The system of claim 1, wherein the compound interest source is an interest-bearing savings account.

13. The system of claim 1, wherein the compound interest source is a mutual fund.

14. The system of claim 1, wherein the periodic contributions comprise an automatic payroll deduction.

15. The system of claim 14, wherein the automatic payroll deduction is pre-tax.

16. The system of claim 1, wherein the desirement date comprises a projected date of retirement.

17. The system of claim 1, wherein adjusting or changing the choice of account based on achieving the maximum value comprises reallocating funds in the user account between multiple investment vehicles.

18. The system of claim 17, wherein the investment vehicles comprise one or more of stocks, bonds, certificates of deposit, derivatives such as options and futures, annuities, mutual funds, exchange-traded funds, precious metals, currencies, real estate, and collectibles.

19. The system of claim 1, wherein adjusting or changing the choice of account based on minimizing costs comprises reallocating funds in the user account in greater proportion to passively managed funds.

20. The system of claim 1, wherein adjusting or changing the choice of account based on minimizing costs comprises reallocating funds in the user account based on annual expenses.

21. The system of claim 1, wherein adjusting or changing the choice of account based on minimizing costs comprises reallocating funds in the user account to no-load investment vehicles.

22. The system of claim 1, further comprising increasing an amount of the periodic contributions by a predetermined percentage each year.

23. The system of claim 1, further comprising periodically adjusting or changing a choice of account based on reducing risk.

24. A method for building retirement income, comprising:
receiving input data from a user to establish a user account;
determining a desirement mortgage representing a maximum value of the account based on the input data;
utilizing a supplemental funding source for achieving the maximum value;
utilizing a compound interest source for achieving the maximum value;
automatically inputting periodic contributions into the account for achieving the maximum value;
determining a desirement date for achieving the maximum value;
periodically adjusting or changing a choice of account based on achieving the maximum value at the desirement date; and
periodically adjusting or changing a choice of account based on minimizing a cost associated with the account choice.

25. The method of claim 24, further comprising transferring at least a portion of funds in the user account to an insured or annuity type or choice of account.

26. The method of claim 24, further comprising inputting some of the periodic contributions into an account with non-taxable gains.

27. The method of claim 24, wherein the desirement mortgage comprises fixed costs and variable costs.

28. They method of claim 27, wherein the fixed costs comprise one or more costs for housing, taxes, utilities, food, and transportation.

29. The method of claim 27, wherein the variable costs comprise one or more costs for experiences, possessions, and achievements.

30. The method of claim 24, wherein the desirement mortgage represents a fixed percentage of annual income.

31. The method of claim 24, wherein the supplemental funding source comprises at least one of a matching employer contribution, a pension plan, or Social Security payments.

32. The method of claim 24, wherein the compound interest source is an interest-bearing savings account.

33. The method of claim 24, wherein the compound interest source is a mutual fund.

34. The method of claim 24, wherein the desirement date comprises a projected date of retirement.

35. The method of claim 24, wherein adjusting or changing the choice of account based on achieving the maximum value comprises reallocating funds in the user account between multiple investment vehicles.

36. The method of claim 35, wherein the investment vehicles comprise one or more of stocks, bonds, certificates of deposit, derivatives such as options and futures, annuities, mutual funds, exchange-traded funds, precious metals, currencies, real estate, and collectibles.

37. The method of claim 24, wherein adjusting or changing the choice of account based on minimizing costs comprises reallocating funds in the user account based on annual expenses.

38. The method of claim 24, further comprising increasing an amount of the periodic contributions by a predetermined percentage each year.

39. A non-transitory computer readable storage medium having embodied thereon a program, the program being executed by a processor to perform a method for building retirement income, the method comprising:
receiving input data from a user to establish a user account;
determining a desirement mortgage representing a maximum value of the account based on the input data;
utilizing a supplemental funding source for achieving the maximum value;
utilizing a compound interest source for achieving the maximum value;
automatically inputting periodic contributions into the account for achieving the maximum value;
determining a desirement date for achieving the maximum value;
periodically adjusting or changing a choice of account based on achieving the maximum value at the desirement date; and
periodically adjusting or changing a choice of account based on minimizing a cost associated with the account choice.

40. The computer readable storage medium of claim 39, further comprising transferring at least a portion of funds in the user account to an insured or annuity type or choice of account.

41. The computer readable storage medium of claim 39, further comprising inputting some of the periodic contributions into an account with non-taxable gains.

42. The computer readable storage medium of claim 39, wherein the desirement mortgage comprises fixed costs and variable costs.

43. The computer readable storage medium of claim 39, wherein the desirement mortgage represents a fixed percentage of annual income.

44. The computer readable storage medium of claim 39, wherein the supplemental funding source comprises at least one of a matching employer contribution, a pension plan, or Social Security payments.

45. The computer readable storage medium of claim 39, wherein the desirement date comprises a projected date of retirement.

46. The computer readable storage medium of claim 39, further comprising increasing an amount of the periodic contributions by a predetermined percentage each year.
